(19) United States
(12) Patent Application Publication
(10) Pub. No.: US 2026/0240711 A1
(43) Pub. Date: Aug. 20, 2026

(54) SMART SENSING MOBILITY CANE

(71) Applicant: Aisha Zaheer, Andover, MA (US)

(72) Inventor: Aisha Zaheer, Andover, MA (US)

(21) Appl. No.: 19/058,304

(22) Filed: Feb. 20, 2025

(51) Int. Cl. A61H 3/06

(52) U.S. Cl. CPC A61H 3/061; A61H 3/068; A61H 2003/063; A61H 2201/5048; A61H 2201/5064

(57) ABSTRACT

Described are safety systems and improved mobility canes that allow visually impaired individuals to detect and avoid waist-high and head-level obstacles. The systems and mobility canes utilize two ultrasonic sensors. One of the two ultrasonic sensors is positioned to detect head-level obstacles and the other ultrasonic sensor is positioned to detect waist-level obstacles. Each of the two sensors provides a different type of feedback thus allowing the user to determine whether a waist-level or head-level obstacle is detected.

### BACKGROUND OF THE INVENTION

About 2.2 billion people worldwide are visually impaired. Many visually impaired individuals rely on conventional mobility aids, also known as white canes, for navigation. The white cane has many advantages including its low cost and simplicity, and can also operate as a signal to notify other persons that the user is blind or visually impaired. Functionally, the user utilizes the white cane to physically scan their surroundings and specifically, to detect ground-level obstacles and discern changes in terrain. For example, the user can sweep the tip of the white cane to the left and right while walking and thereby detect obstacles in their path, such as steps, curbs and other impediments. While white canes offer several advantages, they do not identify waist-up obstacles such as open cabinets, tree branches, water fountains, etc. Visually impaired individuals are thus at a high risk of injury and falls as a result of accidents with objects at chest height or higher (Manduchi, Roberto & Kurniawan, Sri. (2011). Mobility-related accidents experienced by people with visual impairment. Insight: Research and Practice in Visual Impairment and Blindness. 4).

There has long been a need for improved mobility aids which increase safety and help visually impaired people detect and avoid more obstacles than traditional white canes. For example, UltraCane is an electronic white cane that uses “narrow beam” ultrasound system to avoid and detect obstacles at the head/chest level (ultracane.com/about_the_ultracane; U.S. Pat. No. 6,710,706). The UltraCane includes two ultrasound transducers that generate tactile feedback to the user via two vibrating buttons that the user places their thumb over. This feedback is used to indicate to the user the direction and proximity of the obstacle. Sonic Pathfinder, which is head-mounted, is another example of a technology-assisted mobility aid and includes multiple ultrasonic transducers (http://sonicpathfinder.org/pa/pf_blerb.html). Other mobility aids which incorporate GPS have also been developed. However, the currently available technology-assisted mobility aids are expensive and/or require specialized training which have impeded their adoption especially among visually-impaired individuals from underprivileged or disadvantaged populations.

As such, there remains a need in the art for a mobility aid capable of detecting waist-level and head-height obstacles that is relatively low-cost and that requires little specialized training.

### SUMMARY OF THE INVENTION

The present invention is directed to safety systems and improved mobility canes which utilize two ultrasonic sensors (one of which detects a head-level obstacle and the other which detects a waist-level obstacle) and provides a different type of feedback (e.g., haptic or auditory feedback) to the user depending on the location of the obstacle, e.g., head-level or waist-level. The improved mobility cane comprising the safety system described herein helps visually impaired individuals detect and avoid waist-high and up obstacles (referred to herein collectively as “waist-up” obstacles), thereby improving safety and independence while requiring little specialized training.

The invention encompasses a safety system for mounting on a mobility cane (for example, proximal to or as part of the cane handle), the system comprising: a first ultrasonic sensor for detecting a head-level obstacle and a second ultrasonic sensor for detecting a waist-level obstacle; a microcontroller; and a first feedback generator and a second feedback generator; wherein the first ultrasonic sensor is operatively connected to the microcontroller and the first feedback generator, wherein the second ultrasonic sensor is operatively connected to the microcontroller and the second feedback generator, wherein the microcontroller receives information from the first ultrasonic sensor and the second ultrasonic sensor and generates feedback to the user via the first and second feedback generators, respectively, and wherein the feedback generated by the first ultrasonic sensor is different from that of the second ultrasonic sensor. Because different feedback is generated depending on which sensor detects the obstacle, the user is able to easily distinguish a head-level obstacle and a waist-level obstacle based on the different feedback and respond accordingly. In some embodiments, one of the first and the second feedback generators provides haptic feedback to the user, and the other of the first and second feedback generators provides auditory feedback to the user. In some examples, the first feedback generator provides a haptic signal (e.g., the first feedback generator is a haptic motor) and the second feedback generator provides auditory feedback (e.g., second feedback generator is a buzzer or speaker). In another example, the first feedback generator provides auditory feedback (e.g., a buzzer or speaker) and the second feedback generator provides a haptic signal (e.g., a haptic motor). In certain aspects, the safety system further comprises a housing which comprises or houses the first and second ultrasonic sensors, the microcontroller and the first and second feedback generators. The safety system can be detachably mounted on the mobility cane (e.g., a white cane) proximal to or as part of the cane handle such that the first ultrasonic sensor can detect a head-level obstacle and the second ultrasonic sensor can detect a waist-level obstacle.

The invention additionally includes a mobility cane comprising the safety system described herein, for example, proximal to or as part of the cane handle.

The ultrasonic sensors are positioned within the system, relative to each other and/or on the cane such that the first ultrasonic sensor can detect a head-level obstacles and the second ultrasonic sensor can detect a waist-level obstacle.

### BRIEF DESCRIPTION OF THE DRAWINGS

FIGS. 1A and 1B shows two different views of the safety system 1 mounted on a white cane 2 under the cane handle 3. The safety system includes an ultrasonic sensor with two transducers for detecting a head-level obstacle 4 and an ultrasonic sensor with two transducers for detecting a waist-level obstacle 5 and a housing 6 for storing the circuit.

FIG. 2 shows a user 7 holding the mobility cane 2 mounted with the safety system 1 and a waist-level obstacle 8 is shown in the path of the user. The user grips the cane handle and allows the tip of the cane to sweep the ground. The sensors 4 and 5 are positioned to detect a head-level obstacle and a waist-level obstacle, respectively, and information about the obstacles is transmitted to the user by the first and second feedback generators. In one example, the sensor 5 detects the waist-level obstacle 8 and provides feedback to the user so that the user can move around the obstacle 8. In another example, the user sweeps the tip of the cane to the left and right while walking and the sensor 4 can detect a head-level obstacle and the sensor 5 can detect a waist-level obstacle. If the sensor 4 detects a head-level obstacle, haptic feedback is provided to the user and the user can lower their head to avoid the obstacle. If instead, the obstacle remains in the user's path, then the haptic feedback continues, and if the user gets closer to the obstacle, the haptic feedback changes, for example, the intensity of the vibration changes to alert the user that they are getting closer to the obstacle. If the sensor 5 detects a waist-level obstacle, auditory feedback is provided to the user and the user can move away and/or around the obstacle. If the obstacle remains in the user's path then the auditory feedback continues and if the user gets closer to the obstacle, the auditory feedback changes, for example, the volume or frequency of the feedback changes to alert the user that they are getting closer to the obstacle.

FIG. 3 shows an example of the hardware design of the safety system; shown are the breadboard 9, the two ultrasonic sensors 4 and 5, the microcontroller 10, the haptic motor 11, the buzzer 12, the re-chargeable battery 13 (for example, a 3500 mAh battery and charger), a USB port 15 and the transistor 14. The ultrasonic sensor is connected to the microcontroller 10 using the breadboard and the jumper wires, and the speaker 12 is connected to the microcontroller 10 using the breadboard and the jumper wires. The second ultrasonic sensor is connected to the microcontroller using the breadboard and the jumper wires, and the haptic motor is connected to the drain of the transistor and to the haptic motor power is connected to the microcontroller 10 using the breadboard and the jumper wires.

FIG. 4 is a software workflow diagram showing that the microcontroller receives input from the ultrasonic sensors. If an obstacle is detected that is waist-high then user is alerted by the buzzer, and if the obstacle is head-height, the user is alerted through the vibration motor. If the obstacle is avoided then the buzzer or vibration feedback stops; and if the obstacle is still in the path of the user, then it continues to alert the user.

FIG. 5 are graphs showing data from users; specifically, waist-level obstacle detection of the tested system (upper left), the waist-level obstacle avoidance (bottom left), the head-level obstacle detection of the tested system (upper right) and the head-level avoidance (bottom right).

### DETAILED DESCRIPTION OF THE INVENTION

As used herein, the words “a” and “an” are meant to include one or more unless otherwise specified.

The term “about” as used herein, in reference to a numerical value or range, allows for a degree of variability in the value or range, for example, within 20%, within 10%, within 5%, or within 4%, or within 2% of the value or range, depending on the context.

As discussed above, the invention encompasses a safety system and mobility cane (e.g., a white cane) mounted with the safety system as described herein. The invention encompasses a safety system for mounting on a mobility cane (for example, proximal to or as part of the cane handle), the system comprising: a first ultrasonic sensor for detecting a head-level obstacle and a second ultrasonic sensor for detecting a waist-level obstacle; a microcontroller; and a first feedback generator and a second feedback generator; wherein the first ultrasonic sensor is operatively connected to the microcontroller and the first feedback generator, wherein the second ultrasonic sensor is operatively connected to the microcontroller and the second feedback generator, wherein the microcontroller is configured to receive information from the first ultrasonic sensor and the second ultrasonic sensor and generates feedback to the user via the first and second feedback generators, respectively, and wherein the feedback generated by the first ultrasonic sensor is different from that of the second ultrasonic sensor. The systems and canes described herein require little specialized training; for example, the user can use the tip of cane to detect ground-level obstacles and discern changes in terrain in the manner in which they are used to (e.g., by sweeping from one direction to another) and at the same time receive information about head-level obstacles and waist-level obstacles.

The first ultrasonic sensor is positioned for detecting head-level obstacles. The second ultrasonic sensor is positioned for detecting a waist-level obstacle. In certain aspects, the first ultrasonic sensor is positioned above the second ultrasonic sensor relative to the ground, for example, the first ultrasonic sensor can be placed about 2 to about 4 inches above the second ultrasonic sensor. A “head-level” obstacle is an obstacle which the user would be at risk of colliding into with at least part of their head or neck while walking; for example, a head-level obstacle can be about 5 feet or higher above the ground for an adult or teenager. Non-limiting examples of head-level obstacles are a tree branch, a cabinet door, or a low-hanging light fixture. A “waist-level” obstacle is an obstacle which the user would be at risk of colliding into with any part of their body above the waist but below the neck while walking. Non-limiting examples of waist-level obstacles are a table, chair, or a low hanging shelf. The ultrasonic sensors are positioned within the system, relative to each other, and/or mounted on the cane such that the first ultrasonic sensor can detect a head-level obstacle and the second ultrasonic sensor can detect a waist-level obstacle. In certain aspects, the first ultrasonic sensor is positioned on the system above the second ultrasonic sensor; for example, the first ultrasonic sensor can be positioned about 2 to about 4 inches above the second ultrasonic sensor. In certain aspects, the first ultrasonic sensor and/or second ultrasonic sensor is positioned such that the sensor(s) or the transducer(s) are oriented at an upward angle of between about 25° and about 45°, e.g., about 30°, relative to a line perpendicular to the mobility cane. For example, the sensors can be angled when they are mounted on the same platform and the platform is angled relative to the mobility cane. In yet additional aspects, the first ultrasonic sensor and/or second ultrasonic sensor is positioned such that the side of the sensor in greatest proximity to the cane (e.g., the base or plate of the sensor) is mounted at an upward angle between about 25° and about 45°, e.g., about 30°, relative to the mobility cane. In certain additional examples, the first and second ultrasonic sensors are positioned such that the sensor(s) or the transducer(s) are oriented at an angle of between about 25° and about 45°, e.g., about 30°, relative to a line perpendicular to the mobility cane. In yet further aspects, the first ultrasonic sensor and/or second ultrasonic sensor is positioned such that the side of the sensor in greatest proximity to the cane is at an upward angle between about 25° and about 45°, e.g., about 30°, relative to the mobility cane. An exemplary ultrasonic sensor is the HC-SR04. The HC-SR04 includes two ultrasonic transducers. One transducer acts a transmitter to convert the electrical signal in ultrasonic pulses and the other transducer acts as a receiver. In certain aspects, the first ultrasonic sensor and/or the second ultrasonic sensor each comprise two ultrasonic sensors, one of which acts as a transmitter and the other of which acts as a receiver. In additional aspects, each ultrasonic sensor is an HC-SR04 sensor. In yet further aspects, the ultrasonic sensors are waterproof.

In some embodiments, the safety system and mobility cane mounted with the safety system described herein comprises only two ultrasonic sensors which are the first ultrasonic sensor and the second ultrasonic sensor as described herein. In other words, in certain aspects, the safety system or the mobility cane mounted with the safety system includes no ultrasonic sensor in addition to the first ultrasonic sensor and the second ultrasonic sensor. As used herein a system or mobility cane comprises “only two ultrasonic sensors” when there is no ultrasonic sensor in addition to the first ultrasonic sensor and the second ultrasonic sensor as described herein, or in other words, there is not a third ultrasonic sensor. In yet additional aspects, the safety system and mobility cane mounted with the safety system described herein comprises only two sensors (the first ultrasonic sensor and the second ultrasonic sensor as described herein). As used herein a system or mobility cane comprises “only two sensors” when there is no sensor in addition to the first ultrasonic sensor and the second ultrasonic sensor as described herein, or in other words, there is not a third sensor. In yet further examples, the safety system and mobility cane mounted with the safety system described herein does not include a global positioning system (GPS).

The first and second feedback generators each generate different and distinct feedback providing the user with a simple means to distinguish the feedback generated by detection of a head-level obstacle versus the feedback generated by detection of a waist-level obstacle. In some examples, one of the first and second feedback generators provides haptic feedback (vibration) and the other of the first and second feedback generators provides auditory feedback, for example, beeping or a tone. In one embodiment, the first feedback generator provides haptic feedback, for example, a haptic motor. The vibration or haptic feedback can be detected by the user while holding the cane handle. Therefore, in some embodiments, the safety system is mounted near (for example, under the cane handle), is mounted on the cane handle, or is integrated with the cane handle. In some embodiments, the second feedback generator provides auditory feedback, for example, a speaker or a buzzer. In certain embodiments, the first feedback generator provides haptic feedback (for example, a haptic motor), and the second feedback generator provides auditory feedback (for example, a speaker or a buzzer).

The microcontroller is operatively connected, e.g., in electrical communication, to the sensor and to the feedback generators. The microcontroller (for example, an Arduino or Arduino Nano) is programmed to generate feedback when the obstacle is detected within a predetermined distance from the sensor. For example, the microcontroller can be programmed to generate feedback to the user when the waist level obstacle is 60 cm or less from the second sensor. In certain aspects, the microcontroller is programmed to generate feedback to the user when the head level obstacle is 100 cm or less from the first sensor, for example, when the head level obstacle is between 30 and 100 cm, between 35 and 100 cm from the first sensor, or between 40 and 95 cm from the first sensor. In some examples, the microcontroller is programmed to alter the feedback as the distance between the obstacle and the sensor decreases (in other words, as the user holding the mobility cane gets closer to the obstacle). For example, in some aspects, the intensity of the vibration increases with decreasing distance between the obstacle and the sensor. In another example, the microcontroller is programmed to alter the auditory feedback with decreasing distance between the obstacle and the sensor, for example, increasing the volume of the auditory feedback or increasing the frequency of beeps as the distance between the obstacle and sensor decreases.

The system described herein can comprise one more additional components. For example, the system can include a power source, for example, a battery. In certain aspects, the battery is rechargeable. The power source, e.g., the battery can be contained within the housing along with the other components of the system. In some examples, the battery charge lasts at least about 3 hours, at least about 6 hours, at least about 8 hours, at least about 10 hours, at least about 12 hours, at least about 18 hours, at least about 24 hours, at least about 36 hours, at least about 48 hours, at least about 60 hours, at least about 72 hours, or longer.

The invention additionally encompasses a mobility cane comprising a safety system as described herein. For example, the mobility cane can comprise a cane shaft, a cane tip located at one end of the cane shaft, and a cane handle located at the other end of the cane shaft; and a safety system as described herein mounted proximal to the cane handle. In certain aspects, the safety system is mounted under the cane handle. In yet other aspects, the safety system is integrated with or is part of the cane handle. Any type of cane tip can be used, for example, a marshmallow tip, a ball tip or a glide tip. In some examples, the handle includes a means for the user to ascertain if the cane is being held in the correct orientation (e.g., with the sensors positioned appropriately). The length of the cane can vary depending on the height of the user.

In certain aspects, the mobility cane comprising the safety system as described herein weighs 500 grams or less.

### EXEMPLIFICATION

### Example 1: Design and Testing of Smart Sensing Stick (SSS)

### Materials and Methods

Two Ultrasonic Sensors HC-SR04
Jumper wires
Arduino Nano
Mini-B USB Cable
Samsung 18650 26J 5A 2600 mAh Flat Top Rechargeable Battery
Lithium-ion battery holder and charging module
Buzzer
Haptic Motor
Transistor
Box (iPhone Box)
Masking tape
White cane

White canes do not address waist-up challenges and impediments like open cabinets, tree branches, water fountains, etc. To address this issue, the smart sensing stick (SSS) was developed. The SSS is a modified white cane equipped with ultrasonic sensors to detect and navigate around obstacles from the waist up, enhancing safety and independence for the visually impaired. Since the majority of the visually impaired individuals are in underprivileged communities, the product was designed to be affordable and easy to use. Additionally, the system was designed to be lightweight and not cause the white cane to tip to one side.

In prototype 1, one ultrasonic sensor was connected to the Arduino using breadboard and jumper wires and the buzzer/speaker was also connected to the microcontroller.

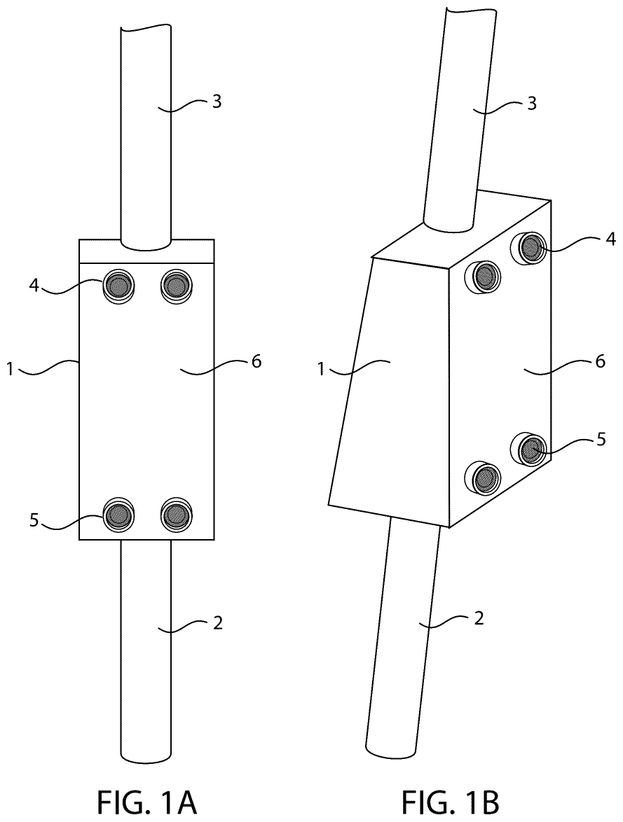

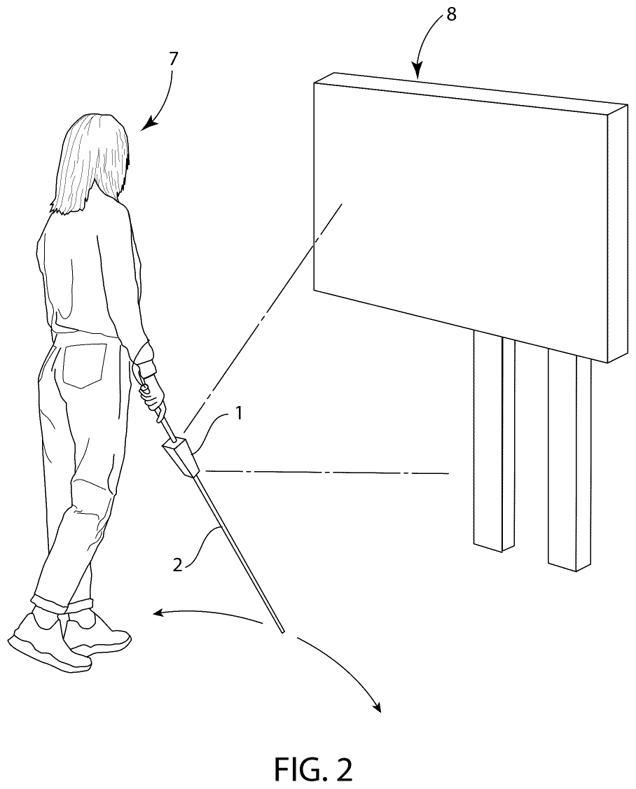

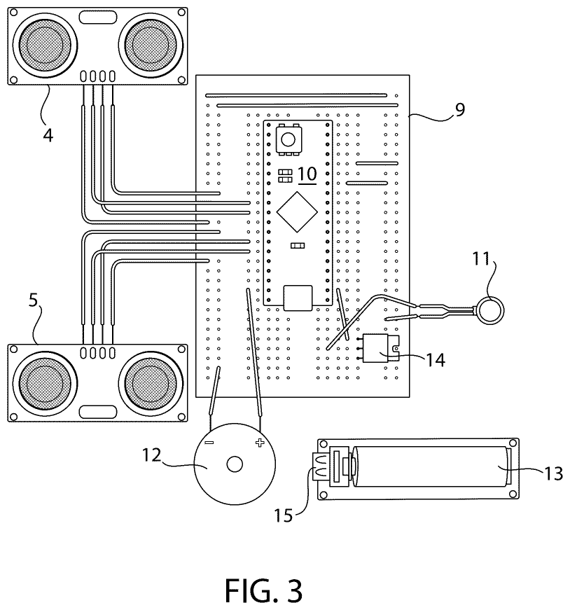

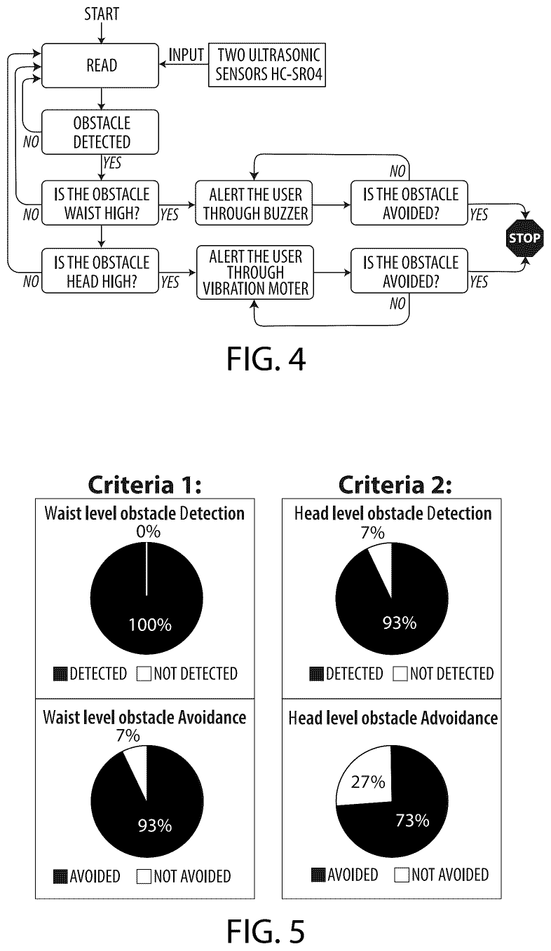

In prototypes 2 and 3, the ultrasonic sensors were connected to the Arduino using breadboard and jumper wires, and the speaker and the haptic motor were also connected to the Arduino. The Arduino was programmed to send a signal to the buzzer for a waist-high obstacle and send a signal to the haptic motor for a head-level obstacle. The whole circuit was placed in a box and mounted on a white cane for testing. A diagram showing the circuit is shown in FIG. 1.

The microcontroller was programmed to read the two ultrasonic sensors. In one design, one sensor was programmed to detect waist-level obstacles, and the other sensor was programmed and positioned to detect head-level obstacles that are within a distance of <60 cm. The user was alerted to the presence of a waist-level and head-level obstacle by sending a signal to the buzzer and haptic motor, respectively. In this design, the head-level sensor was detecting waist-level obstacles resulting in feedback from both the buzzer and haptic motor. Therefore, in another design, the distance range of the head-level sensor was changed from 20-60 cm to 40-95 cm while the distance range of the waist-level sensor was <60 cm, thus avoiding haptic cues for waist-level obstacles.

The different prototypes were tested by three sighted individuals and three visually impaired individuals from the Lowell Association for the Blind (L.A.B.). Brief training was provided to individuals on how to use the SSS.

i. Results and Conclusion

Criteria 1: Ability to detect waist-level obstacles and alert the user with audio cue (buzzer). Testing Procedure: Training was given to the volunteers to move around the obstacle once they heard the beeping sound after the SSS detected the obstacle. Volunteers were asked to walk through a hallway with different waist-level (3 ft and 3.5 ft above ground level) obstacles. Whether the SSS detected the obstacle and whether the user was able to avoid the obstacle was observed and recorded. The data is shown in Table 1 below and in FIG. 5.

TABLE 1

Obstacle 1 (3 feet above ground)

| Trials | Subjects | Detection | Avoidance |
|---|---|---|---|
| Trial 1 | Subject 1 | Yes | Yes |
| | Subject 2 | Yes | Yes |
| | Subject 3 | Yes | Yes |
| Trial 2 | Subject 1 | Yes | No |
| | Subject 2 | Yes | Yes |
| | Subject 3 | Yes | Yes |
| Trial 3 | Subject 1 | Yes | Yes |
| | Subject 2 | Yes | Yes |
| | Subject 3 | Yes | Yes |
| Trial 4 | Subject 1 | Yes | Yes |
| | Subject 2 | Yes | Yes |
| | Subject 3 | Yes | Yes |
| Trial 5 | Subject 1 | Yes | Yes |
| | Subject 2 | Yes | Yes |
| | Subject 3 | Yes | Yes |

Criteria 2: Ability to detect head-level obstacles and alert the user with haptic cue (vibration). Testing Procedure: Training was given to volunteers to duck down once they felt the vibration on the SSS after it detected the head-level obstacle. Volunteers were asked to walk through a hallway with different head-level obstacles. Whether the SSS detected the obstacle and the user was able to avoid the obstacle was observed and recorded. The data is shown in Table 2 below and FIG. 5.

TABLE 2

Obstacle 2 (5.6 feet above ground)

| Trials | Subjects | Detection | Avoidance |
|---|---|---|---|
| Trial 1 | Subject 1 | Yes | Yes |
| | Subject 2 | No | No |
| | Subject 3 | Yes | Yes |
| Trial 2 | Subject 1 | Yes | Yes |
| | Subject 2 | Yes | Yes |
| | Subject 3 | Yes | Yes |
| Trial 3 | Subject 1 | Yes | Yes |
| | Subject 2 | Yes | Yes |
| | Subject 3 | Yes | Yes |
| Trial 4 | Subject 1 | Yes | Yes |
| | Subject 2 | Yes | No |
| | Subject 3 | Yes | Yes |
| Trial 5 | Subject 1 | Yes | No |
| | Subject 2 | Yes | Yes |
| | Subject 3 | Yes | No |

Criteria 3: Should be cost-effective, affordable to a wide range of users. Testing Procedure: The cost of materials used in building SSS was calculated. If produced in bulk the cost could decrease by 30%. Assume 50% profit and add to the cost to calculate the price of the SSS. The calculated price was then compared with a leading mobility device on the market (e.g., Ultracane). The data is shown in Table 3 below:

TABLE 3

| Materials | Quantity | Cost ($) |
|---|---|---|
| Nano Microcontroller | 1 | $7.00 |
| HC-SR04 Ultrasonic sensors | 2 | $3.60 |
| Buzzer | 1 | $0.70 |
| Vibration Motor | 1 | $0.60 |
| Transistor | 1 | $0.80 |
| Jumper wires | 18 | $2.00 |
| Breadboard | 1 | $1.50 |
| Li-ion Battery | 1 | $3.00 |
| Battery holder & charger | 1 | $8.49 |
| White cane | 1 | $12.00 |
| | Total | 39.69 |

Criteria 4: Should be lightweight and cannot tip to one side. Testing Procedure: The weight of the whole prototype including the white cane was measured using a weighing scale. The weight in grams was compared to the weight of the leading mobility device on the market (e.g., Ultracane). The data is shown in Table 4 below:

TABLE 4

| Material | Weight (grams) |
|---|---|
| White cane | 228 |
| Circuit | 193 |
| Battery | 48 |
| Battery holder | 21 |
| Total | 490 |

Constraint 1: Users need to have training in order to effectively use SSS.

Constraint 2: The battery used should last at least a couple of days between charges. The addition of a battery that is 3500 mAh gives about 21 hours of runtime and a charging module makes it rechargeable. This adds a little extra weight to the prototype.

Observations from visually-impaired users that tested the SSS. The visually-impaired users that tested the SSS attested to the need for greater safety than that provided by the traditional white cane noting, for example, that detection of high obstacles was needed, that bumping one's head was routine because the white cane cannot detect head-level obstacles and that the difficulty of determining what is ahead when outside and or in new areas. The users agreed that the SSS would address some of the mobility needs of visually impaired individuals. For example, Participant 1 stated: “One thing that I think that is good for detecting the high things is that you don't want to bump into people, and cause sometimes people aren't so kind when you kinda hit them with your cane. So that's a good thing. This stick [SSS] is neat, it will be a good thing for those of us who are visually impaired. We are always looking for new and great things to enhance our walking and getting around skills.” Participant 2 stated: “Well I'm always hitting my head on stuff, because the white cane doesn't detect high in the head. I usually don't know until I hit it (head high objects). Its top-heavy keeps turning (tilting to one side). I think this stick could be a good thing for us.” Participant 3 stated: “I think we need more of them (the SSS). When you are walking outside or even areas you don't know, you can tell what's in front of you.”

Additional observations. It was observed that when the sensor was placed parallel to the cane, waist-high obstacles were not consistently detected. It was found that positioning the sensors at a 30° angle to the cane improved detection of obstacles. In addition, the presence of two sensors and a rechargeable battery rendered prototype 2 top-heavy causing it to tip to one side because it was attached to one side of the white cane. In prototype 3, the edges of a cardboard box housing the system was carved out and the cane was inserted through the box. During testing, it was also found that the sensor for detecting head-level obstacles was also detecting waist-level obstacles and sending a haptic cue to the user (intended to indicate a head-level obstacle) which resulted in confusion—the user did not know whether to duck down to avoid a head-level obstacle or to move around a waist-level obstacle. The issue was resolved by changing the detection range of the head-level sensor from 20-60 cm to 40-95 cm.

Conclusion: In conclusion, the development of the Smart Sensing Stick (SSS) represents a significant step forward in addressing the navigation challenges faced by visually impaired individuals. By adding ultrasonic sensors into the traditional white cane design, the SSS enhances safety and independence by detecting and navigating around obstacles from the waist up. After many iterations, and incorporating the feedback from visually impaired testers, the SSS met all the criteria successfully. While additional training will be required to ensure complete obstacle avoidance, SSS is affordable and has great potential in improving the daily lives of millions of visually impaired individuals worldwide. Future plans include getting a customized three-dimensional printed enclosure to house the circuit; having the circuit made into a printed circuit board; increasing accessibility of the batter to making charging and powering on/off easier; providing the SSS on canes of different sizes and types (marshmallow tip, ball tip, glide tip, etc.) for people of different heights and preferences; and utilizing waterproof sensors.

All references, articles, patent applications, patent publications and patents are incorporated herein by reference in their entirety. While this invention has been particularly shown and described with references to preferred embodiments thereof, it will be understood by those skilled in the art that various changes in form and details may be made therein without departing from the scope of the invention encompassed by the appended claims.

What is claimed is:

1. A safety system for mounting on a mobility cane, the system comprising:
a first ultrasonic sensor for detecting a head-level obstacle and a second ultrasonic sensor for detecting a waist-level obstacle;
a microcontroller; and
a first feedback generator and a second feedback generator;
wherein the first ultrasonic sensor is operatively connected to the microcontroller and the first feedback generator,
wherein the second ultrasonic sensor is operatively connected to the microcontroller and the second feedback generator,
wherein the microcontroller is configured to receive information from the first ultrasonic sensor and the second ultrasonic sensor and generates feedback to the user via the first and second feedback generators, respectively, and
wherein one of the first feedback generator and the second feedback generator provides haptic feedback to the user, and the other of the first and second feedback generators provides auditory feedback to the user.

2. The system of claim 1, wherein the first feedback generator is a haptic motor.

3. The system of claim 2, wherein the second feedback generator is a buzzer or a speaker.

4. The system of claim 1, wherein the microcontroller is programmed to generate feedback to the user when the waist level obstacle is 60 cm or less from the second sensor.

5. The system of claim 1, wherein the microcontroller is programmed to generate feedback to the user when the head level obstacle 100 cm or less from the first sensor.

6. The system of claim 5, wherein the microcontroller is programmed to generate feedback to the user when the head level obstacle is between 40 and 95 cm from the first sensor.

7. The system of claim 1, wherein the microcontroller is programmed to increase the intensity of the vibration with decreasing distance between the obstacle and the sensor.

8. The system of claim 7, wherein the microcontroller is programmed to alter the auditory feedback with decreasing distance between the obstacle and the sensor.

9. The system of claim 8, wherein the microcontroller is programmed to increase the frequency of the auditory feedback, optionally beeps or tones.

10. The system of claim 1, further comprising a battery.

11. The system of claim 1, further comprising a housing.

12. A mobility cane comprising:
a cane shaft, a cane tip located at one end of the cane shaft, and a cane handle located at the other end of the cane shaft; and
a safety system mounted proximal to the cane handle, wherein the safety system comprises:
a first ultrasonic sensor for detecting a head-level obstacle and a second ultrasonic sensor for detecting a waist-level obstacle;
a microcontroller; and
a first feedback generator and a second feedback generator;
wherein the first ultrasonic sensor is operatively connected to the microcontroller and the first feedback generator,
wherein the second ultrasonic sensor is operatively connected to the microcontroller and the second feedback generator,
wherein the microcontroller is configured to receive information from the first ultrasonic sensor and the second ultrasonic sensor and generates feedback to the user via the first and second feedback generators, respectively, and
wherein one of the first feedback generator and the second feedback generator provides haptic feedback to the user, and the other of the first and second feedback generators provides auditory feedback to the user.

13. The mobility cane of claim 12, wherein the first feedback generator is a haptic motor.

14. The mobility cane of claim 13, wherein the second feedback generator is a buzzer or a speaker.

15. The mobility cane of claim 12, wherein the system is mounted on the mobility cane proximal to the handle of the mobility cane.

16. The mobility cane of claim 12, wherein the microcontroller is programmed to increase the intensity of the vibration with decreasing distance between the obstacle and the sensor.

17. The mobility cane of claim 16, wherein the microcontroller is programmed to alter the auditory feedback with decreasing distance between the obstacle and the sensor.

18. The mobility cane of claim 17, wherein the microcontroller is programmed to increase the frequency of the auditory feedback, optionally beeps or tones.

19. The mobility cane of claim 12, wherein the system is detachably mounted on the mobility cane.

20. The mobility cane of claim 12, wherein the system is enclosed within a housing.
